(19) United States
(12) Patent Application Publication
(10) Pub. No.: US 2005/0066269 A1
(43) Pub. Date: Mar. 24, 2005

(54) Information block extraction apparatus and method for Web pages

(75) Inventors: Jun Wang, Beijing (CN); Jicheng Wang, Nanjing (CN); Gangshan Wu, Nanjing (CN); Hiroshi Tsuda, Kanagawa (JP)

Correspondence Address: STAAS & HALSEY LLP, SUITE 700, 1201 NEW YORK AVENUE, N.W., WASHINGTON, DC, 20005, US

(73) Assignees: Fujitsu Limited, Kawasaki (JP); Nanjing University, Nanjing (CN)

(21) Appl. No.: 10/943,157

(22) Filed: Sep. 17, 2004

(30) Foreign Application Priority Data
Sep. 18, 2003 (CN) 03157365.7

(51) Int. Cl. G06F 17/00

(52) U.S. Cl. 715/513

(57) ABSTRACT

A method and apparatus for identifying coherent areas within a Web page. First, a Web page is parsed into an HTML DOM tree and an HTML tag token stream. Next, repeated-patterns are induced from the Web page. After filtering out improper repeated-patterns and generating corresponding instances of the repeated-patterns, the repeated-patterns are mapped back to corresponding regions in the Web page. Based on the mappings, a hierarchical RST tree containing information blocks is generated. Information items within the information blocks are detected then used to generate a hierarchical structural information block tree. Information blocks from the structural information block tree are then classified into text information blocks and link information blocks. Based on the classification and block semantic similarity, the bocks are clustered then grouped into semantic information blocks. The semantic information blocks contain main text information blocks and related link blocks which, if necessary, can be labeled.

### CROSS-REFERENCE TO RELATED APPLICATIONS

This application is based on and claims priority to Chinese Patent Application No. 03157365.7 filed on Sep. 18, 2003, the contents of which are incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to an apparatus and method for extracting coherent areas within a Web page. The invention segments a Web page into information blocks based on page content and function and extends the granularity of Web page processing from an entire page to an information block therefore making Web pages easier to machine process.

2. Description of the Related Art

Recently, the content and structure of Web pages has gotten more and more complex in order to make them easier to access and friendlier to users. A Web page is usually a collection of various topics and functions loosely combined together. Users can easily identify the information areas having different meanings and functions in a Web page, but it is very difficult for automatic processing systems to identify information areas because HTML (Hyper Text Markup Language) was initially designed for presentation rather than for structured information description. Therefore, most existing web IR (information retrieval), IE (information extraction) and DM (data mining) systems treat the Web page as an atomic element without considering information blocks within the Web page. As a result, many problems occur during machine processing. For example, menu information and advertisements in Web pages lead to garbage in the results of search engines.

For the problems mentioned above, scientists have begun to consider how to segment a Web page based on its content and function. The following are related researches:
Xiaoli Li, Bing Liu, Tong-Heng phang, Minqing Hu, 2002. Using Micro Information Units for Internet Search. CIKM'02, Nov. 4-9, 2002, McLean, Va., USA (“Xiaoli Li 2002”).
Ziv Bar-Yossef and Sridhar Rajagopalan 2002. Template Detection via Data Mining and its Applications. In proceedings of the WWW2002, May 7-11, 2002, Honolulu, Hi., USA (“Ziv Bar-Yossef 2002”).
Soumen Chakrabarti, Mukul Joshi, Vivek Tawde 2001. Enhanced Topic Distillation using Text, Markup Tags, and Hyperlinks. SIGIR'01, Sep. 9-12, 2001, New Orleans, La., USA (“Soumen Chakrabarti 2001”).
Shian-Hua Lin, Jan-Ming Ho 2002. Discovering Informative Content Blocks from Web Documents. SIGKDD'02, Jul. 23-26, 2002, Edmonton, Alberta, Canada (“Shian-Hua Lin 2002”).

Xiaoli Li 2002 and Ziv Bar-Yossef 2002 propose segmenting a Web page into semantically coherent areas, but they both use very simple heuristic methods. The method of Shian-Hua Lin 2002 for detecting information content blocks in a Web page lacks universality since it can process only tabular pages containing <table> tags. Soumen Chakrabarti 2001 segments an HTML DOM (Document Object Model) tree in order to calculate authority and hub scores of the intermediate sub-trees associated with other pages and links, but this is different from the object of the present invention which is to find coherent topic areas of the current page.

### BRIEF SUMMARY OF THE INVENTION

Additional aspects and/or advantages of the invention will be set forth in part in the description which follows and, in part, will be obvious from the description, or may be learned by practice of the invention.

There is provided an inventive method and apparatus for automatically inducing the rules for extracting information blocks within a Web page which can be applied to almost all kinds of Web pages. The method is very effective as it implements information block extraction at two different levels, i.e., structural and semantic levels. Specifically, automatic repeated-pattern discovery at a structural level and clustering at a semantic level are the foundation of the invention, and they guarantee the success of the invention's extraction method. After the information block within the Web page is extracted, machine processing systems such as IR, IE and DM can process the Web pages in a finer granularity and performance is improved significantly.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an embodiment of the invention;

FIG. 2 is a block diagram of the structural information block extraction unit;

FIG. 3 is a block diagram of the semantic information block extraction unit;

FIG. 4 shows an example of a suffix trie with its input token stream;

FIG. 5 show an example of compacting;

FIG. 6 shows an example of information items contained in an information block;

FIG. 7 shows an example of identifying the information items in a leaf node in a RST tree (Root of the smallest Sub Tree);

FIG. 8 shows an example of transforming a sub DOM tree of an inner RST node;

FIG. 9 shows an example of promoting a Head and Tail;

FIG. 10 shows an example of a structural information block tree.

### DESCRIPTION OF THE PREFERRED EMBODIMENTS

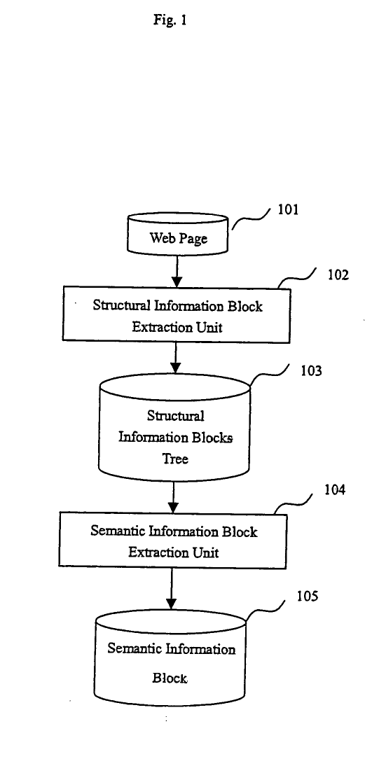

FIG. 1 shows an embodiment of the invention. The input of the apparatus is a Web page 101. Firstly, a structural information block extraction unit 102 constructs a structural information block tree 103 based on repeated-pattern discovery. Then the semantic information block extraction unit 104 extracts a semantic information block 105 from the structural information block tree and labels the main text blocks and related link blocks.

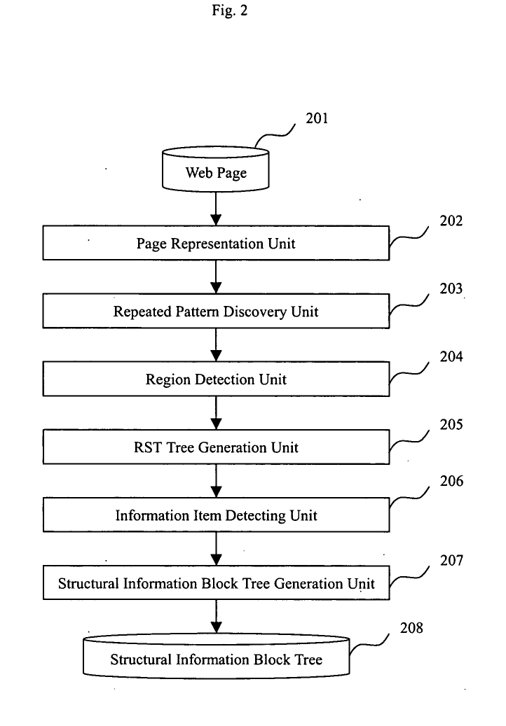

FIG. 2 shows the key operations and related elements for constructing the structural information block extraction unit. First, a page representation unit 202 parses the input Web page 201 into an HTML DOM tree and an HTML tag token stream. Then the repeated-pattern discovery unit 203 induces all the repeated-patterns within the Web page automatically, filters out any improper patterns, and generates sets of candidate patterns and corresponding instances. A region detection unit 204 maps the repeated-pattern back to the corresponding region in the Web page. A RST tree generation unit 205 generates information blocks based on the detected page region and constructs an RST tree with a hierarchical structure. An information item detecting unit 206 identifies all of the information items within each information block. A structural information block tree generation unit 207 constructs the final structural information block tree 208 based on the RST tree.

In the page representation unit 202, an HTML parser constructs the HTML DOM tree of the input Web page, and the DOM tree is traversed with a pre-order to obtain the HTML tag token stream. A mapping table between the tag token stream and the DOM tree is also created. The text in the HTML files is extracted as a special tag <TEXT>.

A suffix trie data structure of the HTML tag token stream is constructed in the repeated-pattern discovery unit 203, and all repeated-patterns and corresponding occurrences are retrieved from the suffix trie.

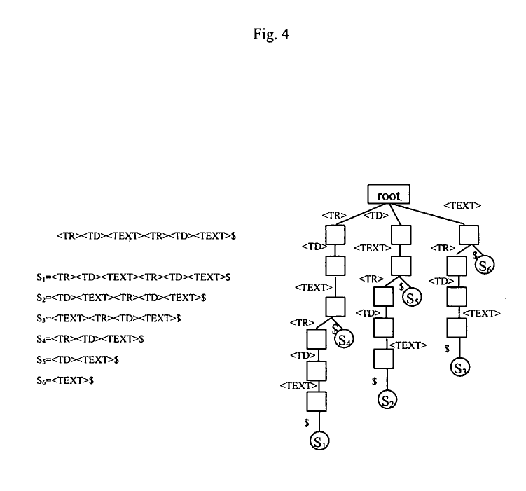

An example of a suffix trie with an input token stream and six token-suffixes is shown in FIG. 4. The suffix trie data structure used for a token stream is defined as (Σ, C, E, N, S, φ, π), where:
Σ is the input token alphabet;
C is the input token sequence, each token cεC, cεΣ;
E is the arc set in the trie where each arc eεE in the suffix trie denotes a token in Σ;
N is the set of inner nodes in the trie;
S is the leaf node set;
φ denotes the dummy trie root; and
π is a partial order over N∪S, which is defined as: n₁πn₂, if n₂ is a node in a sub-trie taking node n₁ as the root.

If two nodes nᵢ and nⱼ have the relationship of nᵢπnⱼ, then a path nᵢeₖ . . . nⱼ connecting the two nodes can be found in the suffix trie. The ordered arc sequence eₖ . . . generated by concatenating the arcs on the path from nᵢ to nⱼ in order is the arc path from nᵢ to nⱼ. The arc path from one node to another node represents a sub-sequence of the input token sequence C. The arc path from the root to a leaf node is a token-suffix of C. The arc path from the root to a fork node, which is a node that has more than one child node, represents a common sub-sequence of a group of token-suffixes. Those suffixes are represented by the arc paths from the root to the leaf nodes that are contained in the sub-trie taking the fork node as the root.

A repeated-pattern with its occurrences is a repeated instance set. Once the suffix trie (Σ, C, E, N, S, φ, π) is constructed, repeated-patterns can be retrieved by directly extracting the arc paths from the root to the fork nodes in the suffix trie.

In this case, fork node Nᵢ is taken as an example to illustrate the retrieval of a repeated-pattern and its occurrences. The repeated-pattern represented by the fork node N₁ is the arc path from the root to the fork node Nᵢ.

$${REP}_{{N}_{i}}^{pattern} = {e}_{1} {e}_{2} {e}_{3} … {e}_{j}$$

An occurrence of the pattern can be represented by a 2-ary tuple <p1, p2>. p1 is the position at which the first token of the pattern

$${REP}_{{N}_{i}}^{pattern}$$

appears in token sequence C. p2 is the position at which the last token of the pattern

$${REP}_{{N}_{i}}^{pattern}$$

appears in token sequence C. Therefore the occurrence set of

$${REP}_{{N}_{i}}^{pattern}$$

is described as:

$${REP}_{{N}_{i}}^{occurrence} = \{ 〈 ψ ( {s}_{m} ) , ψ ( {s}_{m} ) + δ ( ϕ , {N}_{i} ) - 1 〉 \vert ∀ s ∈ S , {N}_{i} π s \}$$

where Ψ(s) denotes the index of the first token of the suffix represented by leaf nodes in the input token sequence and δ(Nᵢ₁, Nᵢ₂) denotes the length of the arc path from Nᵢ₁ to Nᵢ₂. Therefore, the repeated instance set of Nᵢ is

$$< {REP}_{{N}_{i}}^{pattern} , {REP}_{{N}_{i}}^{occurence} > .$$

Other properties of the repeated-pattern can be derived from the repeated instance set. The length of the repeated-pattern is the number of arc in the arc path.

$${REP}_{{N}_{i}}^{length} = ‖ {REP}_{{N}_{i}}^{length} ‖$$

The repetition number of the pattern is computed by counting the number of the elements in the occurrence set.

$${REP}_{{N}_{i}}^{count} = ‖ {REP}_{{N}_{i}}^{occurence} ‖$$

Among the repeated-patterns discovered, some are not the real patterns for information blocks, and such patterns should be filtered out. In addition, repeated-patterns of several information blocks may be the same. For this kind of repeated-pattern, instances from different information blocks are mixed together. Therefore, these instances should be separated.

Three methods of “non-overlapping”, “left diverse” and “compactness” are designed to refine the repeated-patterns and their instances. After pattern refinement, 90% of the original repeated-patterns are filtered out thereby ensuring efficiency and effectiveness of the subsequent steps. The three refinement criteria are illustrated as follows.

The overlapping problem can be expressed as follows: given a repeated-pattern REP^{pattern} with occurrence set REP^{occurrence}, there exists at least two adjacent occurrences <p_{i,1}, p_{i,2}> and <p_{i+1,1}, p_{i+1,2}>, wherein p_{i,2}≧p_{i+1,1}. Such occurrences are referred to as overlapped occurrences, and such a situation should be eliminated to keep non-overlapping.

Given a repeated instance set with REP^{pattern}=eᵢeᵢ₊₁ . . . eᵢ₊ⱼ, a group of repeated instance sets with

$${REP}_{byproduct}^{set} = \{ {REP}_{k}^{pattern} \vert {REP}_{k}^{pattern} = {e}_{i + k} … {e}_{i + j} , 1 < k < j \}$$

may be introduced as byproducts. For example, a repeated-pattern “<TR><TD><TEXT>” with occurrence set {<4,6>,<11,13>,<18,20>} will introduce the by-products, that is, the repeated-pattern “<TD><TEXT>” and “<TEXT>”. The occurrence set of “<TD><TEXT>” is {<5,6>,<12,13>,<19,20>} while the occurrence set of “<TEXT>” is {<6,6>,<13,13>,<20,20>}. The byproducts, i.e., the repeated-pattern set

$${REP}_{byproduct}^{set} ,$$

should be eliminated for they provide no more information than the oriinal REP^{pattern}. All byproduct patterns and only the by product patterns are not left diverse. The term “left diverse” means that the tokens before (at the left side of) each occurrence of the repeated-pattern belong to different token classes. For instance, in the above example, the token before each occurrence of the by product pattern “<TD><TEAT>” belongs to the same token class of “TR”, so the byproduct pattern “<TD><TEXT>” is not left diverse. Thus, if the pattern of a repeated instance set is not left diverse, this repeated instance set should be regarded as a by product and discarded.

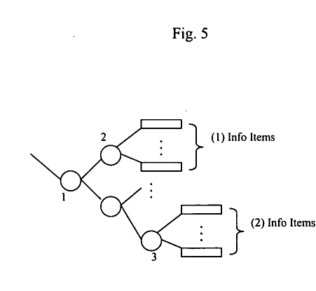

As information items of different information blocks have the possibility of sharing the same repeated-pattern, the common parent of occurrences of a repeated-pattern may not always imply a node for an information block. As shown in FIG. 5, the information items in (1) always have the same format as the information items in (2). Therefore there is a repeated-pattern whose occurrences appears under node 2 and node 3. Node 1 is the common parent of those occurrences, but in fact, node 1 doesn't denote an information block. This uncertainty makes the attempt of discovering the location of an information block by computing the common parent for occurrences of repeated-patterns fail. Fortunately, the information items in an information block are compactly arranged in sequence. This characteristic saves the method of identifying information block based on repeated-patterns.

Given a repeat instance set with REP^{occurrence}={<p₁ⁱ,p₂ⁱ>|1≦i≦k}, we can define a threshold β to segment the occurrence set in order to make them conform to the compact criteria:

$$β = \frac{λ {\sum }_{i = 2}^{k} ( {p}_{1}^{i} - {p}_{2}^{i - 1} )}{k}$$

where k equals

$$‖ {REP}_{{N}_{1}}^{occurrence} ‖$$

and λ is a control parameter. If the interval between occurrences <p₁ⁱ,p₂ⁱ> and <p₁ⁱ⁺¹,p₂ⁱ⁺¹> exceeds β, the occurrence set splits at the position of the interval.

In the region detection unit 204, the repeated-pattern and corresponding instances are mapped back to the HTML DOM tree to obtain the corresponding region in the Web page. For the instance set of each pattern in a Web page, we can find the corresponding nodes (let the number of the nodes be N) in the DOM tree of the page. In the DOM tree, the smallest sub tree, which consists of all the N nodes, is called the smallest sub tree (SST) of the pattern. Here, the root of the SST can be used to denote the SST, and can be referred to as Info RST node (RST, the Root of the Smallest Sub Tree). Each SST is a candidate region in the Web page.

In the RST tree generation unit 205, the RSTs can be organized into a tree structure according to the position of the RSTs in the HTML DOM tree. The construction process of the RST tree is actually a trimming process applied on HTML. It begins with the root of the HTML DOM tree and then cuts off the non-RST nodes. The finally trimmed HTML is an info RST tree.

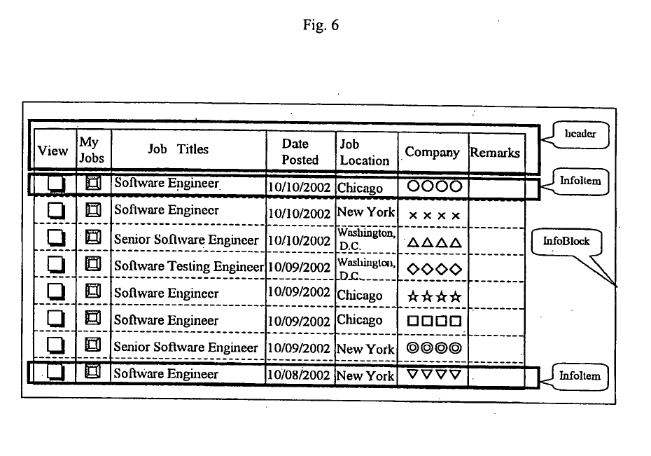

All of the information items within each information block may be identified in the information item detecting unit 206. Each information block is always made up of several information items. In addition, there is often a Head or a Tail or both in an information block, as shown in FIG. 6. Therefore, an information block can be further partitioned into three parts: information item, Head and Tail. The information item is the most important part of the information block. Each item is an individual component in the information block, while different items of a block have similar patterns both in syntax and in presentation. The Head is content belonging to the information block and preceding all of the information items. The Tail is content belonging to the information block and following all of the information items. The method for information item partitioning is illustrated as follows.

First, segment the information block corresponding to a leaf node in a RST tree as follows.

The partitioning of the leaf RST node begins with selecting the qualified repeated instance sets extracted in a previous RST tree construction phase, and then using them to identify the information items. The criteria for assessing appropriate repeated-pattern is described as follows:

Repetition number:
the repetition number of a repeated instance set is computed by counting the number of elements in the occurrence set.

$$rep\_times = ‖ {REP}_{{N}_{i}}^{occurrence} ‖$$

Pattern length: the length of a repeated-pattern is measured as the number of arcs in the arc path.

$$length = ‖ {REP}_{{N}_{i}}^{pattern} ‖$$

Regularity: regularity of a repeated instance set is measured by calculating the standard deviation of the interval between two adjacent occurrences. Given a repeated instance set REP^{instance} with occurrence set REP^{occurrence}={<p₁ⁱ,p₂ⁱ>|1≦i≦k{, the interval between two adjacent occurrences is {p₁ⁱ−p₂ⁱ⁻¹|2≦i≦k}. Regularity of the repeated instance set is equal to the standard derivation of the intervals divided by the mean of the intervals.

Given a, let REP^{instance} \overline{d} be the mean intervals, k be the number of occurrences in the occurrence set, the Regularity of REP^{instance} can be calculated by

$$regularity = \frac{\sqrt{{\sum }_{i = 2}^{k} ( {p}_{1}^{i} - {p}_{2}^{i - 1} - \overline{d} ) 2 / k - 1}}{\overline{d}}$$

Coverage:
coverage is used to indicate the volume of the content contained in the repeated instance set. Let REP^{occurrence}={<p₁ⁱ,p₂ⁱ>|1≦i≦k} be the occurrence set of a given REP^{instance},

$$Coverage = \frac{{p}_{2}^{k} - {p}_{1}^{1}}{‖ {N}^{RST} ‖ }$$

where p₂^{k} is the end position of the last occurrence and p₁¹ is the start position of the first occurrence, ∥N^{RST}∥ is the length of the pre-order traversed token sequence of the smallest sub tree in HTML DOM tree denoted by the RST node N^{RST}.

A ranking method usually applies one or more of those criteria, either separately or in a combined way. In the invention, a ranking method adopting the four criteria is used. The rank of the repeated instance set can be calculated as follows:
IF (Regularity<reg_th)
Rank=−Regularity
ELSE
Rank=−100000;
IF(Coverage>cov_th)
rank=rank+Coverage;
ELSE
rank=rank−100000;
rank=rank+rep_times×length÷Coverage;
(reg_th and cov_th are two control parameters.)

Identification of information items under certain information blocks, in fact, is a process of unit (the child sub trees) clustering. The process of unit clustering is based on the selected repeated instance sets. Assume that the ordered set Π={ST₁,ST₂,ST₃ . . . STᵢ} represents the sub DOM trees under a RST node N^{RST}. The identification algorithm is to segment Π={ST₁,ST₂,ST₃ . . . STᵢ} and produce a result set \overline{Π}={Head,Item₁,Item₂, . . . Itemₖ,Tail}. The Itemᵢ consists of the sub trees representing the i^{the} information item. The Head is the cluster of sub trees that precedes the sub trees representing the first information item, while Tail is the cluster of sub trees that follows the sub trees representing the last information item. The partition is implemented with the help of an Adjacency Array A^{ADJ} for Π. Each tuple of the A^{ADJ} is an integer corresponding to the adjacency of two adjacent elements in Π. Let i start from 0, A^{ADJ}[i] denotes the adjacency of STᵢ₊₁ and STᵢ₊₂ in Π measured by the number of Repeated Instance Set, which contains STᵢ₊₁ and STᵢ₊₂ in a mapping result of one occurrence. Thus, if the number of elements in Π is ∥Π∥, the length of the adjacency array A^{ADL} is ∥Π∥−1. Scope (REP^{instance}) is defined as a group of sub-trees in the DOM tree, which contain the tokens from the start position of the first occurrence and the end position of the last occurrence of REP^{instance}. We define Π^{non-item}={STᵢ|STᵢ∉ Scope(REP^{instance})}, the sub-trees which belong to Π^{non-item} and precede the sub-trees corresponding to Scope (REP^{instance}) are the Head. The sub-trees which belong to Π^{non-item} and follow the sub-trees corresponding to Scope(REP^{instance}) are the Tail.

The parameter τ is used as a threshold for the qualified dividing point. Usually, it is computed as:

$$τ = μ \frac{{\sum }_{i} {A}^{ADL} [ i ]}{‖ {A}^{ADL} ‖}$$

where μ is a constant in the range of 1˜0.5

If A^{ADL}[i]>τ, then STᵢ is the dividing point.

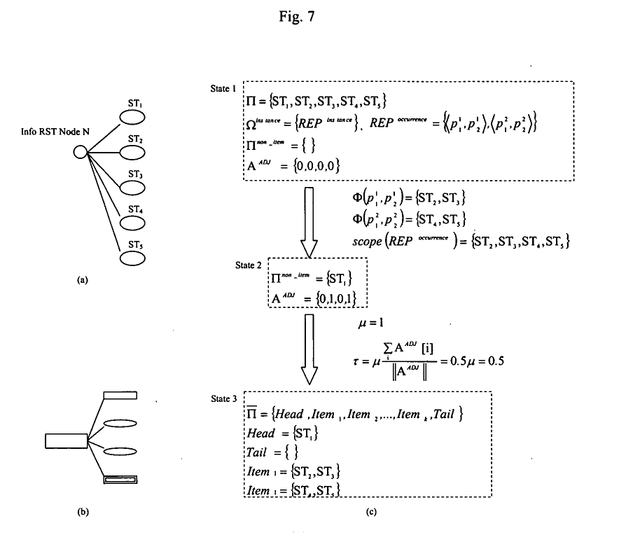

FIG. 7 shows an example of identifying the information items in the leaf node in the RST tree. In this example, the sub DOM tree (shown in FIG. 7(a)) of the RST node N has five sub trees, ST₁, ST₂, ST₃, ST₄ and ST₅. The selected group of repeated instance sets Ω^{instance} associated with N has only one repeated instance set REP^{instance} whose occurrence set REP^{instance} consists of occurrence <p₁¹,p₂¹> and <p₁²,p₂²>. The algorithm begins with the state 1 as described in FIG. 7(c). Through the mapping Φ which maps the occurrence <p₁¹,p₂¹> to <ST₂,ST₃> and the occurrence <p₁²,p₂²> to {ST₄,ST₅} as an example, Π^{non-item} and A^{ADJ} are obtained (shown in state 2, FIG. 7(c)). Due to the fact that Ω^{instance} contains only one repeated instance set with occurrence set REP^{occurrence}, only ST₁ is not included in the result set of scope(REP^{occurrence}), i.e., only ST₁ doesn't represent any information item, so Π^{non-item}={ST₁}; because ST₂ and ST₃ belong to the result set of Φ(<p₁¹,p₂¹>) and ST₄ and ST₅ belong to the result set of Φ(<p₁²,p₂²>), the value of A^{ADJ}[1] and A^{ADJ} [3] is 1 while the value of the other element in A^{ADJ} is 0. The threshold τ for the qualified dividing point is computed from A^{ADJ}, in the example it is set as 0.5. The algorithm makes use of A^{ADJ}, τ and Π^{non-item} to produce the result set \overline{Π}={Head,Item₁,Item₂, . . . Itemₖ,Tail } from Π (shown in state 3, FIG. 7(c)). To construct \overline{Π}, the algorithm firstly checks ST₁ and finds that ST₁ belongs to Π^{non-item} but ST₂ doesn't belong to Π^{non-item}, so the Head only includes ST₁. Because the ST₅ isn't included in Π^{non-item}, the Tail is an empty set. The elements of Π between the last element in the Head set and the first element in the Tail set represent information items. Then the algorithm clusters those elements, which represent information items, based on the adjacency of two adjacent elements. The value of A^{ADJ}[1] exceeds the threshold τ while the value of A^{ADJ}[2] does not exceed the threshold τ, therefore ST₂ and ST₃ are members of Item₁. So are A^{ADJ}[3] and A^{ADJ}[4], which causes ST₄ and ST₅ to form Item₂.

An inner node in the RST tree contains offspring RST nodes which makes the identification of Information items different from the leaf RST node. The repeated instance sets associated with the inner RST node extracted in a previous phase may contain the pattern of an information block denoted by the offspring RST nodes, therefore, such repeated instance sets are not suitable for identifying the information items within inner nodes. As a consequence, the repeated-pattern sets need to be re-extracted by excluding the interference of the offspring RST nodes.

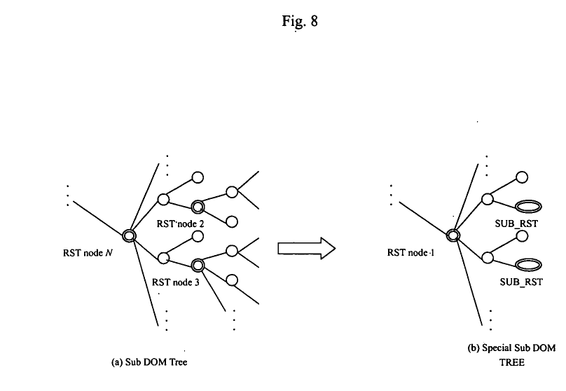

The idea of eliminating the influence of the offspring RST nodes is intuitive and simple. For an inner RST node N, at first, the sub DOM tree of N can be transformed into a special sub DOM tree T^{inner node} by compressing the sub DOM tree of each offspring RST node to a special <SUB_RST> node separately. Therefore, the inner structure of the offspring RST nodes is invisible. FIG. 8 shows a simple example. Next, the special sub DOM tree T^{inner node} is subjected to the pattern discovery algorithm described before and the repeated instance sets associated with the inner RST node N can be retrieved. As long as the special sub DOM tree T^{inner node} and the repeated instance sets of T^{inner node} are provided, the information item identifying process for an inner RST node is the same as for the leaf RST node.

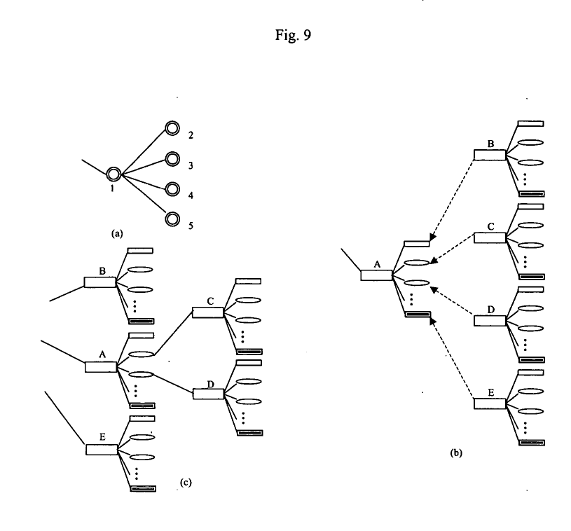

After identifying the information item within the inner RST node, sometimes the Head or Tail of the information block corresponding to the current RST node is a RST node itself. In this case, the Head and Tail nodes should be promoted to a higher level as sibling nodes of the current RST node. FIG. 9 shows an example. Information block A is the corresponding information block of RST node 1. Information block B is the corresponding information block of RST node 2. Information block C is the corresponding information block of RST node 3 and Information block D is the corresponding information block of RST node 4. Information block E is the corresponding information block of RST node 5. According to the info RST sub tree, information block B is a part of the head part of information block A and information block E is a part of the tail part of information block A. So information block B and information block E will be promoted as siblings of information block A, as shown in FIG. 9(c).

In the structural information block tree generation unit 207, the final Structural Information Block Tree is constructed based on the RST Tree and information item detection.

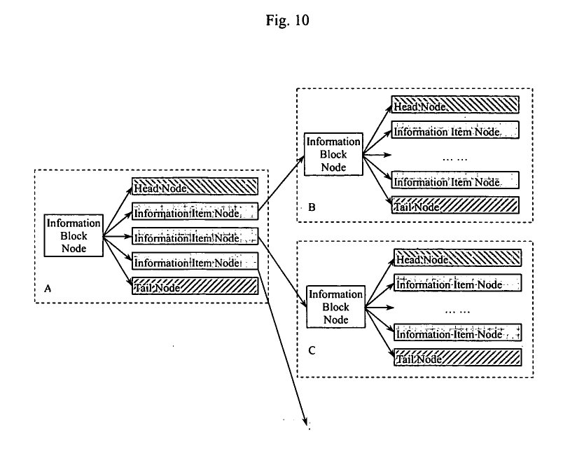

In the RST built before, only the information blocks and their relationship are presented roughly. After detection of information items within information blocks, information block tree can be constructed from the RST tree. The information block tree not only presents information blocks organized hierarchically, but also demonstrates information items in each information block as shown in FIG. 10. Therefore, Web page content can be extracted with finer granularity.

Building a Structural Information Block Tree is a recursive procedure on the RST Tree, which is described as follows:
generate an Information Block node on the tree for the root node of RST Tree;
partition the information items for the current RST node using the method mentioned above, then generate the Information Item node beneath the current Information Block node;
if the current RST node is a non-leaf node, generate an Information Block node for each of its child nodes and append each of these Information Block nodes to the tree beneath an appropriate information item node; and then, process these child Information Block nodes one by one.

In the visual presentation of a Web document, there is usually a name or title for each of the information blocks. In the structure presentation view, the name is associated with one or several adjacent sub trees. Extracting the name of an information block corresponds to locating the sub tree containing the name of the information block by using the structure relationship among the information blocks.

For an structural information block, it is possible that there are many <TEXT> nodes ahead of the information items within the information block. The implied assumption of the present invention is that if an information block has a name or title, the name or title is always the closest <TEXT> node ahead of the first information items. Based on this assumption, the strategy of the invention is: first, consider the head part of the information block. If there is no <TEXT>, search upward from the pre-sibling information block or upper information block until finding a <TEXT>.

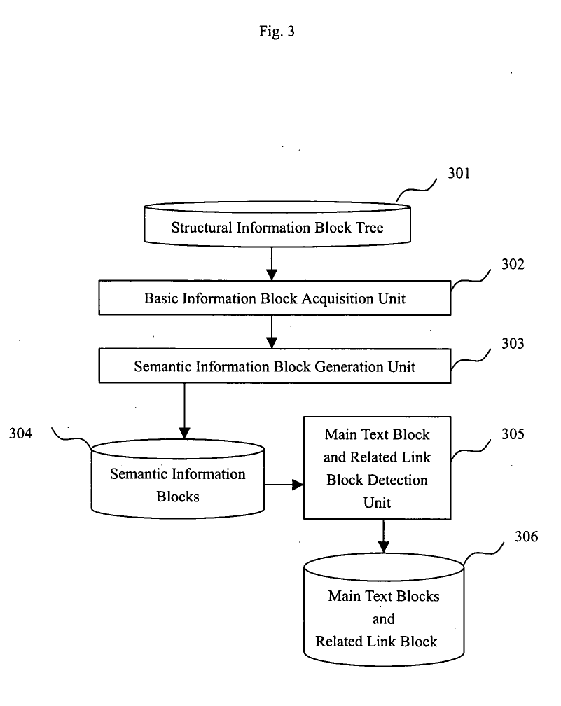

FIG. 3 shows the key steps for constructing a semantic information block extraction unit. First, the basic information block acquisition unit 302 acquires basic information blocks with appropriate granularity from the structural information block tree 301. The semantic information block generation unit 303 clusters and merges the basic information blocks to the semantic information blocks 304. The main text block and related link block detection unit 305 labels the main text information blocks and related link blocks 306 in the semantic blocks of the Web page.

In the basic information block acquisition unit 302, information blocks are obtained from the structural information block tree 301 with appropriate granularity for the following clustering. This kind of block is called “Basic Information Block” and can be classified into two types: text and link. In the invention, some heuristic rules are designed for traversing the structural information block trees in a pre-order to acquire basic information blocks. For each information block traversed, the following rules are applied to determine whether it is a basic information block we need.

TotalLen is the total text length of the current Web page.

$${L}_{total}^{Block}$$

is the total text length in the current Block.

$${L}_{link}^{Block}$$

is the total anchor text length in the current block.

$$ratio = \frac{{L}_{link}^{Block}}{{L}_{total}^{Block}} .$$

IF (the current block contains sub-blocks)
{
$For each sub\_blocks {B}_{child}^{i} under the current block$
{
${ratio}_{i} = \frac{{L}_{link}^{{B}_{child}^{i}}}{{L}_{total}^{{B}_{child}^{i}}}$
}
$ratioIncrease = \frac{{\sum }_{i = 1}^{k} \vert {ratio}_{i} - ratio \vert}{k} ; ( k is the number of sub \text{-} blocks )$
$\begin{matrix}IF ( ( {L}_{total}^{Block} > 0.92 * TotalLen ) ‖ ( ( 0.1 < ratio < 0.45 ‖ ratioIncrease > \\ 0.15 ) \&\& ( {L}_{total}^{Block} > 0.15 * TotalLen ) ) )\end{matrix}$
{
$IF ( {L}_{total}^{Block} > {\sum }_{i = 1}^{k} {L}_{total}^{{B}_{child}^{i}} )$

{Find the missing parts not contained in the structural information tree but in the DOM tree and mark these parts as Basic information Blocks;

```
  }
  For each sub-block B_{child}ⁱ
  {
  Mark B_{child}ⁱ as a basic information block
  }
}
ELSE
{
```

Mark the current block as a basic information block

}
}
ELSE
{

Merge the current block with adjacent leaf block and mark the result as a basic information block;

}

All the basic information blocks are scanned, if the length of a basic information block is less than 50, it is merged into the next adjacent basic information block.

The final basic information blocks can be classified into two types: text information blocks and link information blocks according to the ratio value of the block.

In the semantic information block generation unit 303, semantic clustering is performed based on the basic information blocks so as to generate semantic information blocks for the Web page. Each block is represented in the form of “bag of words”, i.e. a set of <word, frequency>, in order to compute the semantic similarity between two blocks. A stop-list is also used to remove general words with little meaning.

Clustering is performed on text information blocks and link information blocks respectively. A common method known as “partitional clustering” is used, which is described as follows:
Arrange the blocks in a descending order according to the size of the blocks;
Append the longest block to the current cluster;
For each block in the current cluster, compute the similarity to other blocks not yet clustered. The similarity can be computed with different methods such as VSM or word-overlapping. Moreover, when two adjacent blocks are more similar, the similarity between two adjacent blocks is doubled;
If the similarity is above a threshold, append the block not yet clustered to the current cluster. Repeat the above loop until each block is processed. Now, all information blocks in the current cluster are grouped into a semantic information block;
Select the longest block from all the information blocks left as the seed of a new cluster. Repeat the above loop. If all of the basic information blocks are clustered into a certain semantic information block, the procedure ends.

In the main text block and related link block detection unit 305, if necessary, we can label the main text information block and related link block in the semantic blocks of a Web page. After the generation of a semantic information block, if the content of Web page is mainly text instead of link, it is necessary to extract the main text block. The method is described as follows.

Check the ratio of link to text. If it is below a threshold, then the Web page is most likely a text page. Otherwise, quit.

Identify the longest text block in the Web page. If the length is above a threshold, it can be regarded as a main text block. Otherwise, semantic clustering method is applied on the text information blocks to generate a main text block.

If a main text block is generated, then select one block from the link information blocks which is most similar to the main text block. If the similarity is above a threshold, then this link block is regarded as a related link block. Otherwise, no related block exists.

Although a few embodiments of the present invention have been shown and described, it would be appreciated by those skilled in the art that changes may be made in these embodiments without departing from the principles and spirit of the invention, the scope of which is defined in the claims and their equivalents.

1. A method for segmenting a Web page into information blocks with coherent contents comprising:
generating a structural information block tree of the Web page;
clustering and merging the structural information blocks; and
labeling the semantic of the resulting blocks.

2. The method of claim 1, wherein generating a structural information block tree comprises:
inducing repeated-patterns within the Web page;
matching the repeated-pattern and the corresponding region in the Web page;
constructing an RST tree (Root of the Smallest Subtree) according to the regions;
identifying information items within each information block; and
constructing the structural information block tree based on the RST tree and the information items.

3. The method of claim 2, wherein generating a structural information block tree comprises:
representing the Web page with both an HTML DOM tree and an HTML tag token stream.

4. The method of claim 3, wherein generating a structural information block tree comprises:
filtering out improper repeated-patterns; and
generating sets of candidate patterns and corresponding instances.

5. The method of claim 2, wherein generating a structural information block tree comprises:
filtering out improper repeated-patterns.

6. The method of claim 2, wherein generating a structural information block tree comprises:
generating sets of candidate patterns and corresponding instances.

7. The method of claim 1, wherein clustering and merging the structural information blocks comprises:
acquiring basic information blocks with appropriate granularity from the structural information block tree; and
clustering and merging the basic information blocks to generate semantic information blocks.

8. The method of claim 7, wherein labeling the semantic of the resulting blocks comprises:
labeling a main text information block and related link block in the semantic information blocks of the Web page.

9. An apparatus for segmenting a Web page into information blocks with coherent contents comprising:
a structural information block extracting unit generating a structural information block tree of the Web page; and
a semantic information block extracting unit clustering and merging the structural information blocks and labeling the semantic of the resulting blocks.

10. The apparatus of claim 9, wherein the structural information block extracting unit comprises:
a repeated-pattern discovery unit inducing repeated-patterns within the Web page;
a region detection unit matching the repeated-pattern and the corresponding region in the Web page;
a RST tree generation unit constructing an RST tree according to the regions;
an information item detecting unit identifying information items within each information block; and
a structural information block tree generation unit constructing the structural information block tree based on the RST tree and the information items.

11. The apparatus of claim 10, wherein the structural information block extracting unit comprises a page representation unit representing the Web page with both an HTML DOM tree and an HTML tag token stream.

12. The apparatus of claim 11, wherein the repeated-pattern discovery unit filters out improper repeated-patterns and generates sets of candidate patterns and corresponding instances.

13. The apparatus of claim 10, wherein the repeated-pattern discovery unit filters out improper repeated-patterns.

14. The apparatus of claim 10, wherein the repeated-pattern discovery unit generates sets of candidate patterns and corresponding instances.

15. The apparatus of claim 9, wherein the semantic information block extracting unit comprises:
a basic information block acquisition unit acquiring basic information blocks with appropriate granularity from the structural information block tree; and
a semantic information block generation unit clustering and merging the basic information blocks to generate semantic information blocks.

16. The apparatus of claim 15, wherein the semantic information block extracting unit comprises:
a main text block and related link block detection unit labeling a main text information block and related link block in the semantic information blocks of the Web page.

17. A method for segmenting a Web page into information blocks with coherent contents comprising the steps of:
extracting structural information blocks from the Web page; and
generating semantic information blocks based on the structural information blocks.
